(19) United States
(12) Patent Application Publication
(10) Pub. No.: US 2017/0095909 A1
(43) Pub. Date: Apr. 6, 2017

(54) RECESSED FASTENER, FORMING PUNCH AND DRIVING TOOL

(71) Applicant: ESSENCE METHOD REFINE CO., LTD., TAINAN CITY (TW)

(72) Inventor: LING-FANG CHEN, TAINAN CITY (TW)

(21) Appl. No.: 14/874,679

(22) Filed: Oct. 5, 2015

(51) Int. Cl. B25B 15/00; B25B 15/02; B21K 1/46; F16B 23/00

(52) U.S. Cl. CPC B25B 15/005; F16B 23/003; B25B 15/02; B21K 1/463

(57) ABSTRACT

A recessed fastener includes a head with a top face and a drive socket, a shank extending downward from the head, and threads helically around the shank. The drive socket has a bottom and drive walls extending upward therefrom. The bottom meets the drive walls at a bottom border. The drive walls meet the top face at a top border. The bottom border and the top border have respective first and second corners. The first corners are rotatably offset relative to the second corners. A joining line is connected between each first corner and each second corner, and one drive wall formed between two adjacent joining lines is in a spiral form. The spiral drive walls leads a driving tool toward the bottom to produce an automatic downward pressing force which facilitates the close engagement, thereby obtaining a quick driving operation, an increased driving power and a labor-saving effect.

### BACKGROUND OF THIS INVENTION

1. Field of this Invention

This invention relates to a driving system and relates particularly to a recessed fastener with a drive socket, a punch adapted to form the drive socket and a driving tool for use therein.

2. Description of the Related Art

International universal recesses of screw heads for engaging with driving tools, as shown in FIG. 1, may include slotted sockets, cruciform sockets, “Pozi” sockets, square sockets, hexagonal sockets, “Torx” (6-points star-shaped) sockets, etc.

With regard to hexagonal, Torx and square sockets, a top face of the screw head is generally subjected to the highest driving force when the head is perpendicular to a driving tool. For driving the screw head, a user must give the driving tool a downward pressing force to prevent the driving tool from escaping from the socket easily.

With regard to Pozi, sockets, cruciform sockets or other sockets with a slope, the cooperative driving tool can be inserted in or withdrawn from the socket easily to facilitate the driving action. However, the user still has to give the driving tool a further downward pressing force manually to prevent the escape of the tool.

Different screws with different sockets in the market are driven by a manual downward pressing force given to the driving tool. Thus, the operation requires enough rotating and downward pressing forces. This, however, causes the burden of using screws and tools and incurs the inconvenience of the use.

If there is an insufficient downward pressing force, the driving tool gets away from the socket easily. It is also possible that the socket becomes deformed and broken easily when the driving tool does not engage with the socket completely, and this problem may reduce the operating life of the fastener.

### SUMMARY OF THIS INVENTION

An object of this invention is to provide a driving system which includes a recessed fastener with a drive socket where an automatic downward pressing force is produced to facilitate an entry of a driving tool. A corresponding punch for forming the socket on the fastener and a driving tool for engaging therewith are also disclosed.

A recessed fastener of this invention comprises a head with a top face, a shank extending downward from the head, and a plurality of threads helically disposed around the shank. A drive socket is depressed in the top face of the head. The drive socket has a bottom and a plurality of connective drive walls extending upward from the bottom to the top face. The bottom meets the drive walls at a bottom border. The drive walls meet with the top face at a top border. The bottom border has a plurality of first corners. The top border has a plurality of second corners. The number of the first corners and the number of the second corners are the same. The first corners are rotatably offset relative to second corners, and a joining line is connected between each first corner and each second corner. Thus, each of the drive walls formed between two adjacent joining lines is in a spiral form. When a driving tool enters the drive socket by rotating forces of the user, the spiral drive walls allow the driving tool to generate an automatic downward pressing force and to go toward the bottom and come into close engagement with the drive walls of the drive socket. Accordingly, the user renders the driving tool able to engage with the fastener automatically without giving a further manual downward pressing force. Therefore, a quick driving operation, an increased driving power and a labor-saving effect can be obtained. Further, the driving tool for use in such drive socket and a punch which forms such drive socket are also disclosed to facilitate a smooth operation and a quick and convenient production.

Preferably, the first corners and the second corners are curved.

Preferably, the first corners and the second corners have a sharp point so that the aforementioned corners can have an angularly sharp form.

Preferably, the bottom border defines a first maximum outer diameter and a first minimum inner diameter. The top border defines a second maximum outer diameter and a second minimum inner diameter. In following preferred embodiments, the first maximum outer diameter can be equal to or less than the second maximum outer diameter. The first minimum inner diameter can be equal to or less than the second minimum inner diameter.

A further object of this invention is to provide a punch which forms the drive socket of the recessed fastener. The punch has a punch body and a punch shank protruding outward from the punch body. The punch shank includes a first end, a second end opposite to the first end and punch walls spirally extending from the first end to the second end. The punch walls are complementary in shape with the drive walls of the drive socket of the fastener.

A further object of this invention is to provide a driving tool for use in the drive socket of the recessed fastener. The driving tool includes a driving shaft and a driving part connected to the driving shaft. The driving part has a plurality of spiral wall portions for engagement with the drive walls of the drive socket when the driving part is inserted into the drive socket.

The advantages of this invention over the known prior arts are more apparent upon reading following descriptions in conjunction with the accompanying drawings.

### BRIEF DESCRIPTION OF THE DRAWINGS

FIG. 1 is a top plan view showing international universal drive sockets of a conventional design;

FIG. 2 is a schematic view showing a first preferred embodiment of a recessed fastener of this invention;

FIG. 3 is a top plan view of FIG. 2;

FIG. 4 is a cross-sectional view of FIG. 2;

FIG. 5 is a top plan view showing a variation of the first preferred embodiment of this invention;

FIG. 6 is a top plan view showing a further variation of the first preferred embodiment of this invention;

FIG. 7 is a top plan view showing a further variation of the first preferred embodiment of this invention;

FIG. 8 is a top plan view showing a further variation of the first preferred embodiment of this invention;

FIG. 9 is a top plan view showing a second preferred embodiment of a recessed fastener of this invention;

FIG. 10 is a cross-sectional view of FIG. 9;

FIG. 11 is a top plan view showing a third preferred embodiment of a recessed fastener of this invention;

FIG. 12 is a cross-sectional view of FIG. 11;

FIG. 13 is a top plan view showing a fourth preferred embodiment of a recessed fastener of this invention;

FIG. 14 is a cross-sectional view of FIG. 13;

FIG. 15 is a schematic view showing a driving tool used in the head of the first preferred embodiment of this invention;

FIG. 16 is a perspective view showing a punch which forms the drive socket of this invention; and

FIG. 17 is a perspective view showing a driving tool for use in the head of the fastener of this invention.

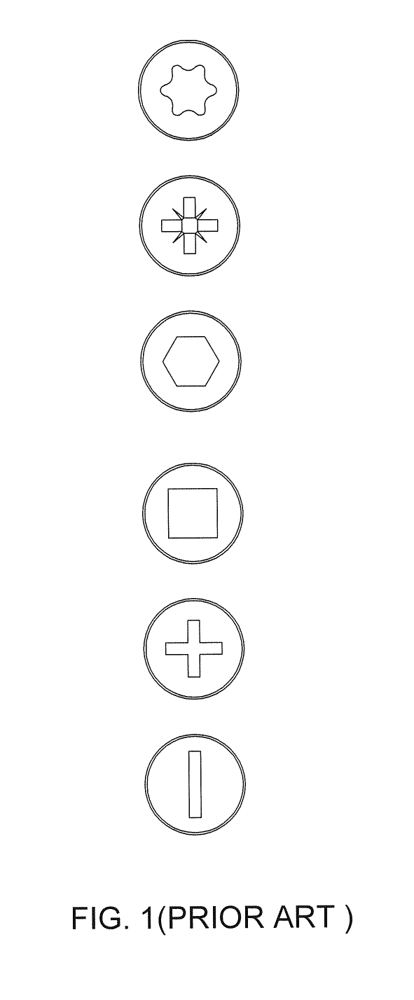

### DETAILED DESCRIPTION OF THE PREFERRED EMBODIMENTS

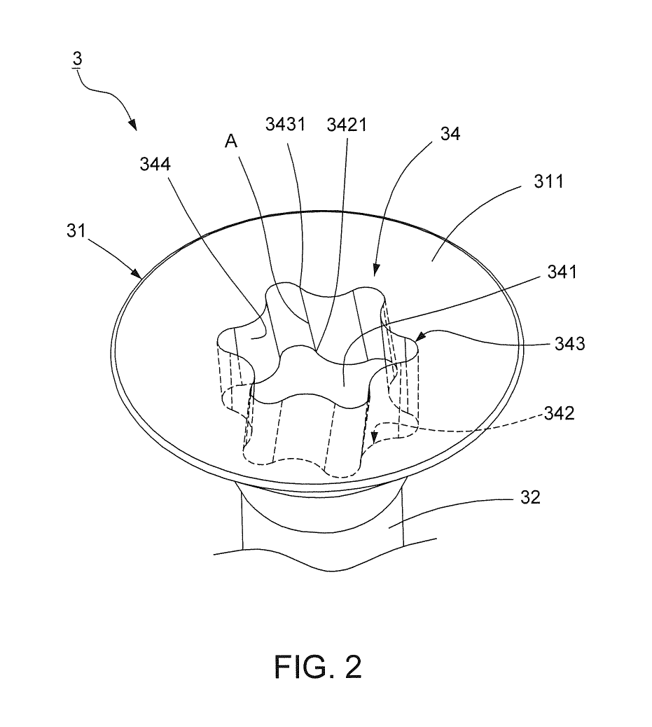

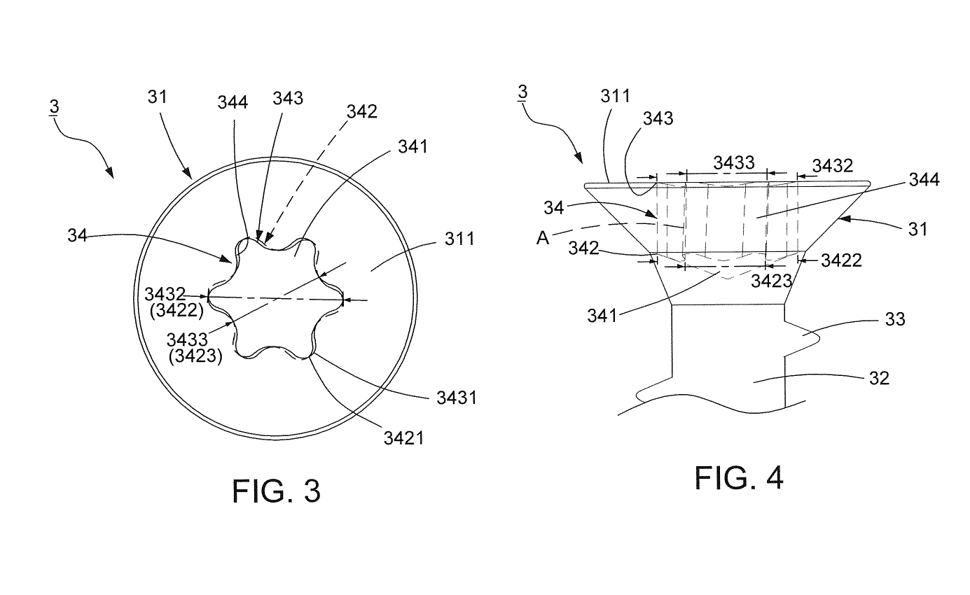

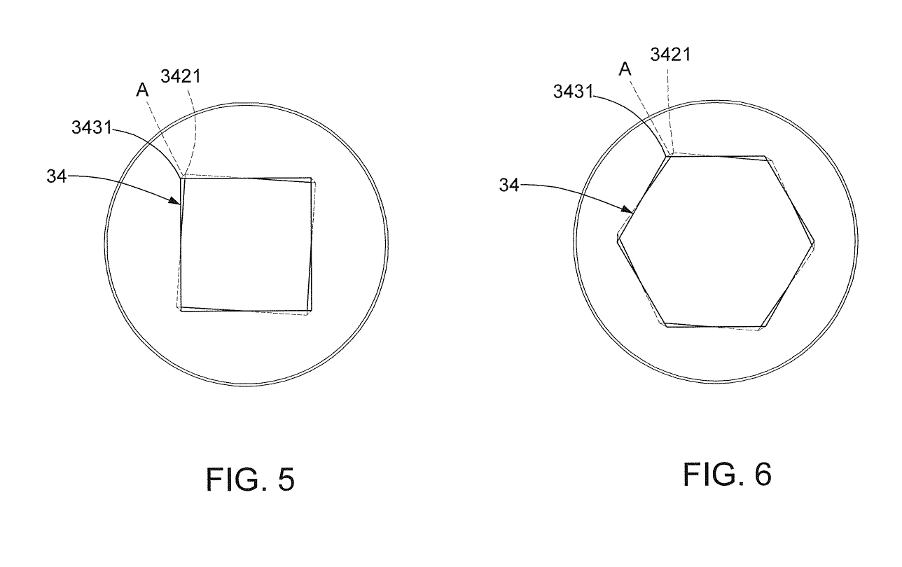

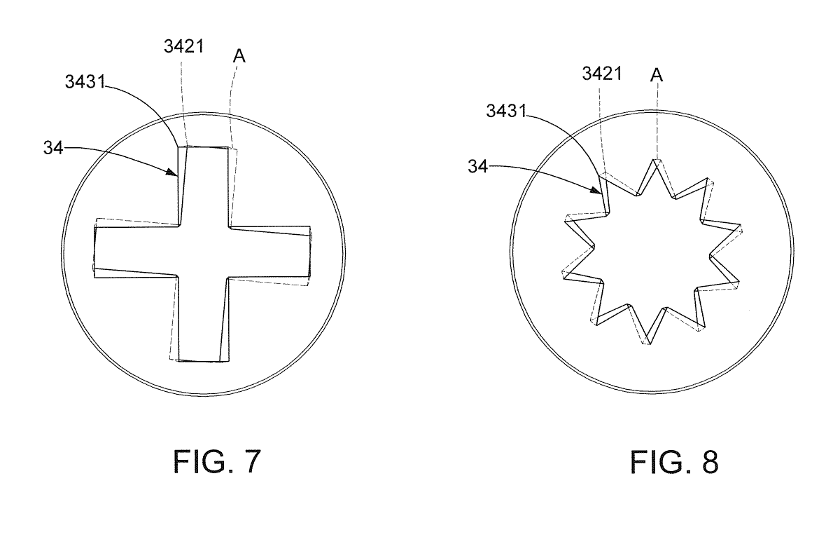

Referring to FIGS. 2 to 4, a recessed fastener 3 of a first preferred embodiment of this invention includes a head 31, a shank 32 extending downward from the head 31, and a plurality of threads 33 spirally disposed around the shank 32. The head 31 has a top face 311 opposite to the shank 32 and a drive socket 34 depressed in the top face 311. The drive socket 34 has a bottom 341 and a plurality of drive walls 344 extending upward from the bottom 341 to the top face 311. The bottom 341 meets the drive walls 344 at a bottom border 342, and the drive walls 344 meet with the top face 311 at a top border 343. The bottom border 342 has a plurality of first corners 3421, and the top border 343 has a plurality of second corners 3431. The number of the first corners 3421 is equal to the number of the second corners 3431. The first bottom border 342 and the top border 343 are not directed in a same direction. In other words, the first corners 3421 are rotatably offset at an angle relative to the second corners 3431, as clearly seen in FIG. 3 and FIGS. 5 to 8. Further, a joining line “A” is connected between each first corner 3421 and each second corner 3431, so each of the drive walls 344, formed between the two adjacent joining lines “A” and shown in FIG. 2, can be in a spiral form. Further, the corners 3421, 3431 can have different contours. In this preferred embodiment, the first corners 3421 and the second corners 3431 are curved whereby the drive socket 34 is a Torx socket where six lobes are shown. Alternatively, the first corners 3421 and the second corners 3431 can have a sharp point whereby the drive socket 34 can be a square socket as shown in FIG. 5, a hexagonal socket as shown in FIG. 6, a cruciform socket as shown in FIG. 7, a star-shaped socket as shown in FIG. 8, etc. The operation of this invention will be described in detail with the fastener 3 having the Torx socket 34.

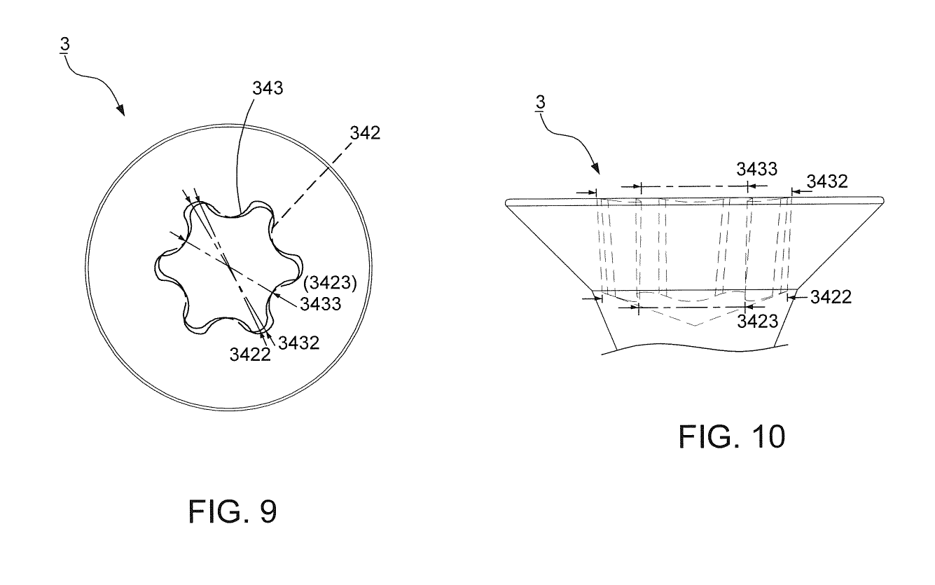

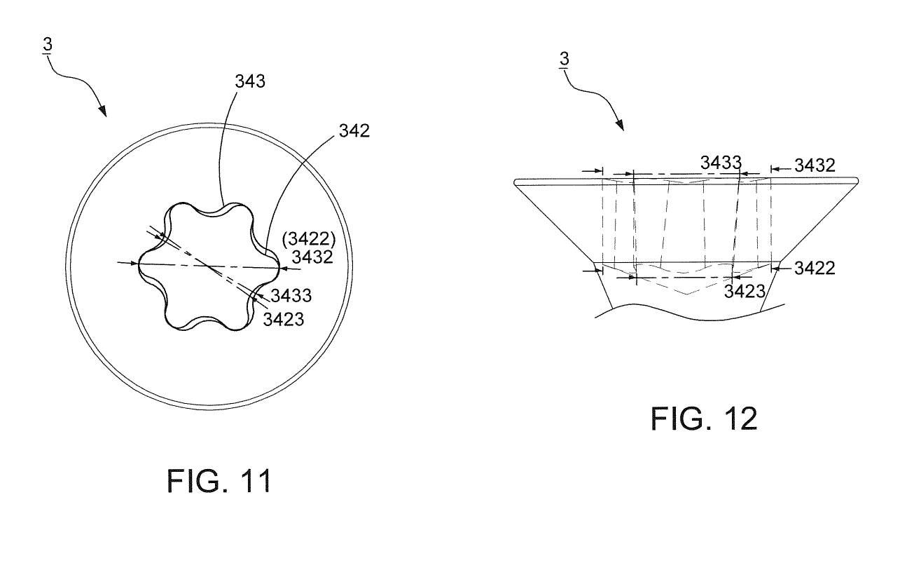

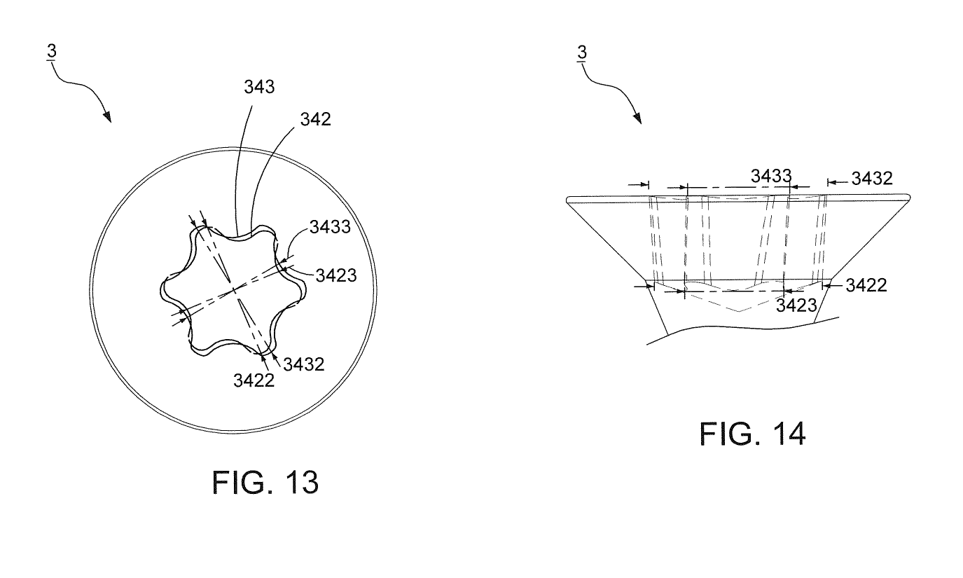

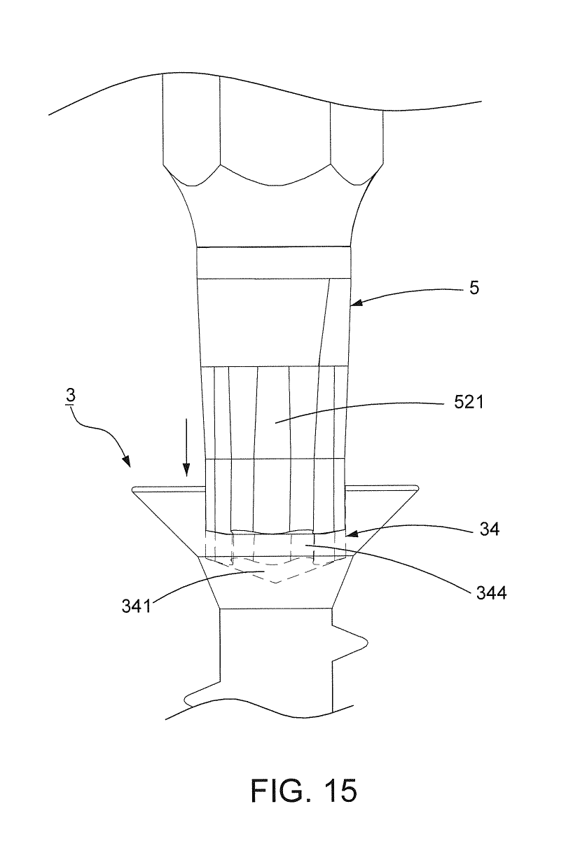

Furthermore, the bottom border 342 defines a first maximum outer diameter 3422 and a first minimum inner diameter 3423, and the top border 343 defines a second maximum outer diameter 3432 and a second minimum inner diameter 3433. These maximum outer diameters and minimum inner diameters can be the same or different. For example, FIGS. 2 to 4 show that the first maximum outer diameter 3422 is equal to the second maximum outer diameter 3432, and the first minimum inner diameter 3423 is also equal to the second minimum inner diameter 3433. FIG. 9 and FIG. 10 show that the first maximum outer diameter 3422 is less than the second maximum outer diameter 3432, and the first minimum inner diameter 3423 is equal to the second minimum inner diameter 3433. FIG. 11 and FIG. 12 show that the first maximum outer diameter 3422 is equal to the second maximum outer diameter 3432, and the first minimum inner diameter 3423 is less than the second minimum inner diameter 3433. FIG. 13 and FIG. 14 show that the first maximum outer diameter 3422 is less than the second maximum outer diameter 3432, and the first minimum inner diameter 3423 is less than the second minimum inner diameter 3433. It is noted that the reference numbers 3422, 3423 put in brackets in some figures represent the invisible diameters 3422, 3423 when they are equal to other diameters 3432, 3433. These variations in the outer and inner diameters of the bottom border 342 and the top border 343 cause the drive walls 344 to become spiral and inclined, and such structure allows a driving tool 5, as briefly shown in FIG. 15, to be engaged with the drive walls 344 more easily. The operation of this invention is described in detail with the type shown in FIG. 2.

The operation of this invention is explained with the aid of FIG. 2, FIG. 3 and FIG. 15 where a driving tool 5 is used in the drive socket 34. The driving tool 5 has a plurality of wall portions 521. The number and the shape of the wall portions 521 are the same as those of the drive walls 344. When the driving tool 5 is put into the drive socket 34 and rotated, the wall portions 521 rotatably and smoothly move along the spiral form of the drive walls 344, and concurrently driving forces which drive or push the wall portions 521 converge on the bottom 341 to produce an automatic downward pressing force, as arrowed in FIG. 15. Thus, the wall portions 521 can enter the drive socket 34 automatically to be in close contact with the drive walls 344, and the user can engage the wall portions 521 with the drive walls 344 closely without a further manual downward pressing force exerted on the driving tool 5. In other words, the user only gives the tool 5 a rotating force to rotate the tool 5 but does not need to give the tool 5 a further downward pressing force. This operation allows the user to save labor and use conveniently and also allows the driving tool 5 to come into close engagement with the fastener 3 automatically, thereby obtaining a rapid engaging effect and an increased driving power. The structure can solve the conventional problems, such as the escape of the driving tool 5 from the drive socket 34 because of the insufficient press-down force and the broken drive socket 34 caused by the incomplete engagement between the tool 5 and the socket 34. Therefore, the driving operation is easier and more convenient to carry out.

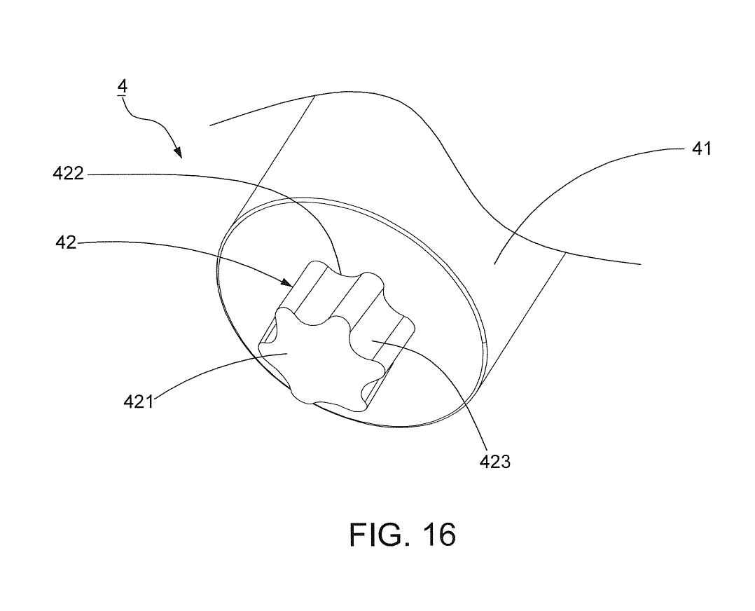

FIG. 16 shows a punch 4 which forms the drive socket 34 of the recessed fastener 3 as described above. The punch 4 includes a punch body 41 and a punch shank 42 protruding outward from the punch body 41. The punch shank 42 has a first end 421, a second end 422 opposite to the first end 421 and a plurality of punch walls 423 spirally extending from the first end 421 to the second end 422. When the punch shank 42 punches the socket 34 on the head 31 of the fastener 3, the drive walls 344 can easily be formed by the punch walls 423 and provided with a spiral angle which is the same as that of the punch walls 423. Thus, the fasteners 3 as shown in previous four embodiments are quickly made.

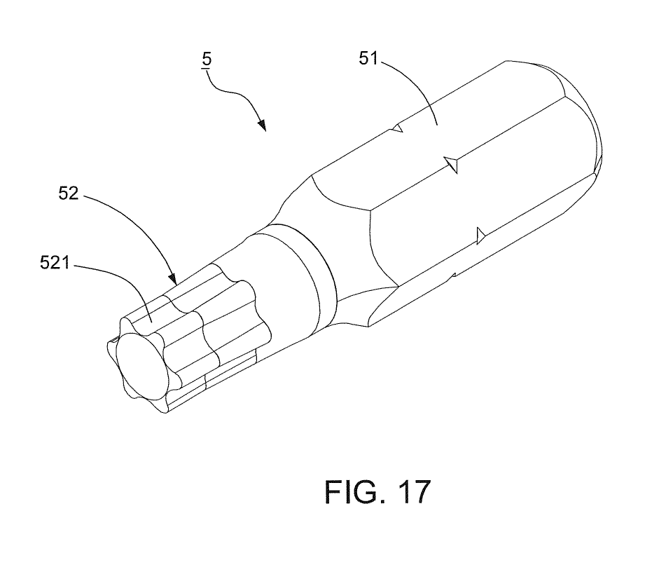

Referring to FIG. 17, a driving tool 5 for use in the drive socket 34 of the recessed fastener 3 as described above includes a driving shaft 51 and a driving part 52 connected to the driving shaft 51. The driving part 52 has a plurality of spiral wall portions 521 for being in engagement with the drive walls 344 of the above recessed fastener 3. When the driving part 52 is inserted into the drive socket 34 of the fastener 3 as aforementioned and then rotated, the wall portions 521 can engage with the drive walls 344 closely to prevent the driving tool 5 from swinging and escaping at the time of operating. The use of the tool 5 is more stable and more convenient.

To sum up, this invention takes advantage of the spiral drive walls to lead the driving tool toward the bottom of the drive socket naturally, which facilitates the generation of an automatic downward pressing force during the operation and provides a close engagement between the driving tool and the drive walls. While the user gives a rotating force, the driving tool is automatically driven to move toward the bottom of the drive socket for having a close engagement with the drive walls without imparting a further downward pressing force. Thus, a quick stable combination, an increased driving power and a labor-saving effect can be obtained. Further, a driving tool for use in such drive socket of the recessed fastener and a punch which forms the drive socket are also provided to facilitate a smooth operation and a quick and convenient production.

While the embodiments of this invention are shown and described, it is understood that further variations and modifications may be made without departing from the scope of this invention.

What is claimed is:

1. A recessed fastener comprising:
a head including a top face opposite to said shank and a drive socket depressed in said top face;
a shank extending downward from said head; and
a plurality of threads helically disposed around said shank;
wherein said drive socket has a bottom and a plurality of drive walls extending upward from said bottom to said top face, said bottom meeting said plurality of drive walls at a bottom border, said plurality of drive walls meeting said top face at a top border, said bottom border having a plurality of first corners, said top border having a plurality of second corners, a number of said first corners being equal to a number of said second corners, said plurality of first corners being rotatably offset relative to said plurality of second corners, a joining line being connected between each of said plurality of first corners and each of said plurality of second corners, each of said plurality of drive walls being formed between any two adjacent joining lines, each of said plurality of drive walls being in a spiral form.

2. The recessed fastener according to claim 1, wherein said first corners and said second corners are formed in a curved shape.

3. The recessed fastener according to claim 1, wherein said first corners and said second corners have a sharp point.

4. The recessed fastener according to claim 1, wherein said bottom border defines a first maximum outer diameter and a first minimum inner diameter, said top border defining a second maximum outer diameter and a second minimum inner diameter, said first maximum outer diameter being equal to said second maximum outer diameter, said first minimum inner diameter being equal to said second minimum inner diameter.

5. The recessed fastener according to claim 1, wherein said bottom border defines a first maximum outer diameter and a first minimum inner diameter, said top border defining a second maximum outer diameter and a second minimum inner diameter, said first maximum outer diameter being less than said second maximum outer diameter, said first minimum inner diameter being equal to said second minimum inner diameter.

6. The recessed fastener according to claim 1, wherein said bottom border defines a first maximum outer diameter and a first minimum inner diameter, said top border defining a second maximum outer diameter and a second minimum inner diameter, said first maximum outer diameter being equal to said second maximum outer diameter, said first minimum inner diameter being less than said second minimum inner diameter.

7. The recessed fastener according to claim 1, wherein said bottom border defines a first maximum outer diameter and a first minimum inner diameter, said top border defining a second maximum outer diameter and a second minimum inner diameter, said first maximum outer diameter being less than said second maximum outer diameter, said first minimum inner diameter being less than said second minimum inner diameter.

8. A punch for forming the drive socket of the recessed fastener of claim 1, said punch comprising a punch body and a punch shank protruding outward from said punch body;
wherein said punch shank includes a first end, a second end opposite to said first end and a plurality of punch walls spirally extending from said first end to said second end, said plurality of punch walls being complementary in shape with the plurality of drive walls of the drive socket of the recessed fastener of claim 1.

9. A driving tool for use in the drive socket of the recessed fastener of claim 1, said driving tool comprising a driving shaft and a driving part connected to said driving shaft;
wherein said driving part has a plurality of spiral wall portions capable of being in engagement with the drive walls of the drive socket of the recessed fastener of claim 1 when said driving part is inserted into the drive socket.
